(19) United States
(12) Patent Application Publication
(10) Pub. No.: US 2026/0171030 A1
(43) Pub. Date: Jun. 18, 2026

(54) SCAN DRIVING CIRCUIT AND DISPLAY DEVICE INCLUDING THE SAME

(71) Applicant: LG Display Co., Ltd., Seoul (KR)

(72) Inventors: Sung Jin LEE, Paju-si (KR); Jung Yul YANG, Paju-si (KR); Do Hun KWAK, Paju-si (KR)

(73) Assignee: LG Display Co., Ltd., Seoul (KR)

(21) Appl. No.: 19/374,954

(22) Filed: Oct. 30, 2025

(30) Foreign Application Priority Data
Dec. 17, 2024 (KR) 10-2024-0188843

(51) Int. Cl. G09G 3/3266; G09G 3/3233

(52) U.S. Cl. CPC G09G 3/3266; G09G 3/3233; G09G 2300/0842; G09G 2310/08; G09G 2320/041; G09G 2320/043; G09G 2330/021

(57) ABSTRACT

A display device can include a pixel circuit configured to drive a light emitting element, and a scan driving circuit configured to supply a scan signal to the pixel circuit. The scan driving circuit can include a logic portion to receive clock signals and output a logic signal through a logic output terminal, and an inverter to receive the logic signal and output the scan signal with a phase of the logic signal inverted through a gate output terminal. The inverter includes a first inverter transistor of n-type and a second inverter transistor of a p-type transistor, in which gate electrodes the first and second inverter transistors are both connected to the logic output terminal of the logic portion, the first and second inverter transistors are both connected to the gate output terminal. Also, the first inverter transistor can include an oxide semiconductor.

### CROSS-REFERENCE TO RELATED APPLICATIONS

This application claims priority to Korean Patent Application No. 10-2024-0188843, filed in the Republic of Korea on Dec. 17, 2024, the entirety of which is hereby incorporated by reference into the present application as if fully set forth herein.

### BACKGROUND

### Field of the Disclosure

The present disclosure relates to a scan driving circuit and a display device including the same.

### Discussion of the Related Art

Various methods and forms have been used for display devices that display images on TVs, monitors, smartphones, tablets, laptops, etc.

The display devices include a display panel having a plurality of light emitting elements or liquid crystals for implementing an image, and a transistor for controlling an operation of each light emitting element or liquid crystal, to display an image as desired through the plurality of light emitting elements or liquid crystals.

Recent display devices include various flat display devices such as electroluminescence display devices including organic light emitting diode (OLED) display devices, quantum dot light emitting diode (QLED) display devices, and micro-LED (micro-light emitting diode) display devices.

A display device can include a display panel that displays an image and a driving unit that drives the display panel. The display panel includes a plurality of pixels including light emitting elements, and the driving unit can include a plurality of driving and switching elements to drive and control light emitting elements provided in each pixel.

The driving unit can include a scan driving circuit that supplies scan signals synchronized with data signals to gate lines provided in a plurality of pixels. However, the transistors in the scan driving circuit can degrade after prolonged use. For example, the transistors in the scan driving circuit can exhibit an undesirable positive shift in their threshold voltage when subjected to prolonged positive bias thermal stress (PBTS) during operation, particularly when operating at a low speed driving or under high temperature conditions. Thus, a need exists for a display device having a scan driving circuit with an improved configuration that can prevent an undesirable threshold voltage shift, reduce power consumption, and ensure stable, long-term operational reliability under various conditions.

### SUMMARY OF THE DISCLOSURE

Accordingly, the present disclosure is directed to a scan driving circuit and a display device including the same that substantially obviates one or more problems due to limitations and disadvantages of the related art.

A technical task of embodiments of the present disclosure is to provide a scan driving circuit with improved reliability and a display device including the same.

A technical task of embodiments of the present disclosure is to provide a structure of a scan driving circuit capable of reducing the number of clock signals and simplifying operation.

A technical task of embodiments of the present disclosure is to provide a structure capable of mitigating an operation error of a scan driving circuit that may occur due to Positive Bias Thermal Stress (PBTS).

A technical task of embodiments of the present disclosure is to implement ESG by improving reliability of a display device and reducing power consumption.

Additional advantages, objects, and features of the disclosure will be set forth in part in the description which follows and in part will become apparent to those having ordinary skill in the art upon examination of the following or can be learned from practice of the disclosure. The objectives and other advantages of the disclosure can be realized and attained by the structure particularly pointed out in the written description and claims hereof as well as the appended drawings.

To achieve these objects and other advantages and in accordance with the purpose of the disclosure, as embodied and broadly described herein, a display device includes a substrate including an active area and a non-active area, a pixel circuit located in the active area and configured to drive a light emitting element, and a scan driving circuit configured to supply a scan signal to the pixel circuit, in which the scan driving circuit includes a logic unit (e.g., logic portion) configured to receive a plurality of clock signals and output a logic signal through a logic output terminal, and an inverter configured to receive the logic signal and output the scan signal with a phase of the logic signal inverted through a gate output terminal, in which the inverter includes a first inverter transistor having n-type and a second inverter transistor having p-type, a gate electrode of each of the first and second inverter transistor is connected to the logic output terminal, and the first and second inverter transistor are connected to the gate output terminal interposed therebetween, and the first inverter transistor includes an oxide semiconductor.

A period during which a gate high voltage of the logic signal is supplied to a gate electrode of the first inverter transistor can be longer than a period during which a gate low voltage of the logic signal is supplied.

The second inverter transistor can include a semiconductor formed of low temperature polysilicon (LTPS).

The first inverter transistor can have a gate electrode connected to the logic output terminal, one end to which a gate low voltage (VGL) is supplied, and the other end connected to the gate output terminal, and the second inverter transistor can have a gate electrode connected to the logic output terminal, one end to which a gate high voltage (VGH) is supplied, and the other end connected to the gate output terminal.

The first inverter transistor can be turned on by the logic signal having a gate high voltage to output the scan signal having a gate low voltage to the gate output terminal, and the second inverter transistor can be turned on by the logic signal having a gate low voltage to output the scan signal having the gate high voltage to the gate output terminal.

The logic unit (e.g., logic portion) can include a plurality of logic transistors, and the plurality of logic transistors can include a semiconductor formed of LTPS.

The logic unit (e.g., logic portion) can include a first logic transistor having a gate electrode connected to a Q-node, one end to which a first clock signal is input, and the other end connected to the logic output terminal, a second logic transistor having a gate electrode connected to a QB-node, one end to which a gate high voltage is supplied, and the other end connected to the logic output terminal, a third logic transistor having a gate electrode to which a second clock signal is input, one end to which a start signal is input, and the other end connected to the Q-node, a fourth logic transistor having a gate electrode connected to the Q-node, one end to which the second clock signal is input, and the other end connected to the QB-node, a fifth logic transistor having a gate electrode to which the second clock signal is input, one end to which a gate low voltage is input, and the other end connected to the QB-node, a sixth logic transistor having a gate electrode connected to the QB-node and configured to output a gate high voltage supplied at one end to the other end, a seventh logic transistor having a gate electrode to which a first clock signal is input, one end connected to the sixth logic transistor, and the other end connected to the Q-node, a first capacitor having one end connected to the Q-node, and the other end connected to the logic output terminal, and a second capacitor having one end connected to the QB-node, and the other end to which a logic high voltage is supplied.

The logic unit (e.g., logic portion) can further include an eighth logic transistor having a gate electrode to which a gate low voltage is supplied and connected between the gate electrode of the first logic transistor and the other end of the third logic transistor.

In a first period, the start signal and the second clock signal have a logic low voltage, and the first clock signal has a logic high voltage, in a second period after the first period, the first clock signal has a logic low voltage, and the second clock signal has a logic high voltage, in a third period after the second period, the second clock signal has a logic low voltage, and the first clock signal and the start signal have a logic high voltage, and in a fourth period after the third period, the first clock signal has a logic low voltage, and the second clock signal has a logic high voltage.

The first inverter transistor can include a bottom electrode positioned on the other side of the gate electrode with respect to the oxide semiconductor, and the display device can further include a first switch having one end connected to the gate electrode and the other end connected to the bottom electrode, and a second switch having one end commonly connected to the bottom electrode and the first switch and the other end to which a constant voltage is supplied.

The first switch can be turned on and the second switch can be turned off while the scan driving circuit outputs the scan signal at a first scan rate or higher.

The first switch can be turned off and the second switch can be turned on while the scan driving circuit outputs the scan signal at a scan rate less than a first scan rate. In another aspect of the present disclosure, a scan driving circuit includes a logic unit configured to receive a plurality of clock signals and output a logic signal through a logic output terminal to supply a scan signal to a pixel circuit located in an active area of a substrate, and an inverter configured to receive the logic signal and output the scan signal with a phase of the logic signal inverted through a gate output terminal, in which the inverter includes a first inverter transistor having n-type and a second inverter transistor having p-type, the first and second inverter transistor are connected to the gate output terminal interposed therebetween, and the first inverter transistor includes an oxide semiconductor.

A period during which a logic high voltage of the logic signal is supplied to a gate electrode of the first inverter transistor can be longer than a period during which a logic low voltage of the logic signal is supplied.

The second inverter transistor can include a semiconductor formed of LTPS.

The first inverter transistor can have a gate electrode connected to the logic output terminal, one end to which a gate low voltage (VGL) is supplied, and the other end connected to the gate output terminal, and the second inverter transistor can have a gate electrode connected to the logic output terminal, one end to which a gate high voltage (VGH) is supplied, and the other end connected to the gate output terminal.

The first inverter transistor can be turned on by the logic signal having a gate high voltage to output the scan signal having a gate low voltage to the gate output terminal, and the second inverter transistor can be turned on by the logic signal having a gate low voltage to output the scan signal having the gate high voltage to the gate output terminal.

The first inverter transistor can include a bottom electrode positioned on the other side of a gate electrode positioned on one side with respect to the oxide semiconductor, and the scan driving circuit can further include a first switch having one end connected to the gate electrode and the other end connected to the bottom electrode, and a second switch commonly connected to the bottom electrode and the other end of the first switch and configured to control supply of a constant voltage.

The first switch can be turned on and the second switch can be turned off while the scan driving circuit outputs the scan signal at a first scan rate or higher.

The first switch can be turned off and the second switch can be turned on while the scan driving circuit outputs the scan signal at a scan rate less than a first scan rate.

It is to be understood that both the foregoing general description and the following detailed description of the present disclosure are examples and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a diagram for describing an example of a display device according to an embodiment of the present disclosure;

FIG. 2, including parts (a) and (b), is a diagram for describing an example of an equivalent circuit for a subpixel SP according to an embodiment of the present disclosure;

FIG. 3 is a diagram for describing a scan driving circuit according to an embodiment of the present disclosure;

FIG. 4 is a diagram for describing an example of a timing diagram applied to the scan driving circuit according to an embodiment of the present disclosure;

FIGS. 5 to 8 are diagrams for describing an operation method of the scan driving circuit based on the timing diagram of FIG. 4 according to an embodiment of the present disclosure;

FIG. 9 is a diagram for describing a scan driving circuit according to another embodiment of the present disclosure;

FIG. 10, including parts (a) and (b), is a diagram for describing an operation of the scan driving circuit during high-speed operation at a first scan rate or higher according to an embodiment of the present disclosure; and

FIG. 11, including parts (a) and (b), is a diagram for describing an operation of the scan driving circuit during low-speed operation at less than the first scan rate according to an embodiment of the present disclosure.

### DETAILED DESCRIPTION OF THE EMBODIMENTS

Hereinafter, embodiments will be described with reference to the drawings.

Identical drawing symbols refer to identical components. In addition, some parts of the drawings can be exaggerated for effective description of the thickness, ratio, and dimensions of the components. The scale of the components depicted in the drawings is different from the actual scale for convenience of description, and is not limited to the scale depicted in the drawings.

In the present disclosure, when a component (or region, layer, portion, etc.) is referred to as being “on,” “connected to,” or “coupled to” another component, it means that the component can be directly connected/coupled to the other component, or that a third component can be disposed therebetween.

“And/or” includes all of one or more combinations that can be defined by associated components.

Even though the terms first, second, etc. can be used to describe various components, the components are not limited by the terms. The terms are only used to distinguish one component from another. For example, without departing from the scope of the present embodiments, a first component can be referred to as a second component, and similarly, the second component can also be referred to as the first component. The singular expression includes the plural expression unless the context clearly indicates otherwise.

The terms “below,” “lower,” “above,” and “upper,” etc. are used to describe relationships between components depicted in the drawings. The terms are relative concepts and are described based on directions indicated in the drawings. For example, one or more other components can be located between two components, unless “immediately” or “directly” is used. The spatially relative terms “below,” “beneath,” “lower,” “above,” “upper,” etc. can be used to easily describe a relationship between one element or component and another element or component, as depicted in the drawings. Thus, for example, “below” and “lower” with respect to a first component can be in the opposite direction to “above” and “upper” with respect to the first component.

Spatially relative terms should be understood to include different directions of elements when used or operated in addition to the directions depicted in the drawings. For example, when elements depicted in the drawings are flipped over, an element described as “below” or “beneath” another element can be placed “above” the other element. Thus, the example term “below” can include both lower and upper directions.

It should be understood that a term such as “include” or “have” is intended to designate that the features, numbers, steps, operations, components, parts, or combinations thereof described in the specification are present, and does not preclude the possibility of addition or presence of one or more other features, numbers, steps, operations, components, parts, or combinations thereof.

Features of each of several embodiments of the present disclosure can be partially or wholly combined or mixed with one another, and can be technically linked and operated in various ways, and respective embodiments can be implemented independently of one another or can be implemented together in an interrelated manner. Also, the term “can” used herein includes all meanings and definitions of the term “may.”

Hereinafter, a gate on voltage can be a voltage of a gate signal at which a transistor can be turned on. A gate off voltage can be a voltage at which the transistor can be turned off. In a P-type transistor, the gate on voltage can be a logic low voltage VL, and the gate off voltage can be a logic high voltage VH. In an N-type transistor, the gate on voltage can be a logic high voltage, and the gate off voltage can be a logic low voltage.

Hereinafter, a display device of the present disclosure will be examined as below through the attached drawings and embodiments.

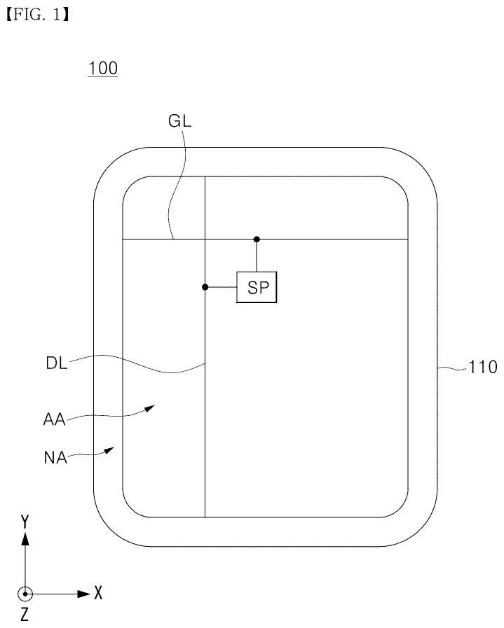

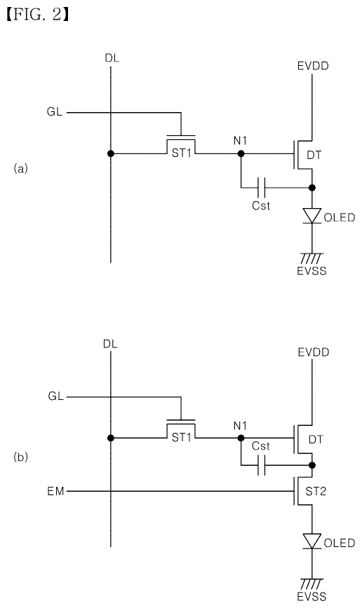

FIG. 1 is a diagram for describing an example of the display device applicable to the present disclosure, and FIG. 2 is a diagram for describing an example of an equivalent circuit for a subpixel SP applicable to the display device of the present disclosure.

Referring to FIGS. 1 and 2, a display device 100 according to an example of the present disclosure includes a display panel 110, and the display panel 110 can include an active area AA and a non-active area NA.

The active area AA can be an area for displaying an image. A plurality of subpixels SPs are arranged in the active area AA of the display panel 110, and an image can be displayed using the plurality of subpixels SPs. The area where the plurality of subpixels SPs is arranged can be the active area AA, and an area other than the active area AA can be the non-active area NA.

The non-active area NA can be arranged in a border region surrounding the active area AA in which an image is displayed. At least one driving unit for driving a plurality of subpixels SPs can be arranged in the non-active area NA. The driving unit can be a Gate-In-Panel (GIP).

At least one driving unit can include a scan driving circuit for supplying scan signals to a plurality of subpixels SPs arranged in the active area AA. In addition, various additional elements can be further arranged in the non-active area NA to drive subpixels SPs in the active area AA.

However, the present disclosure is not necessarily limited thereto, and for example, the scan driving circuit can be distributed in the active area AA. For example, in the active area AA, a pixel area where pixels are positioned and a circuit area where the scan driving circuit is located can be located horizontally alternately.

In addition, the display device 100 of the present disclosure can include a timing controller that supplies timing control signals including clock signals (e.g., CLK1 and CLK2) and a start signal GVST to the scan driving circuit, and can include a power circuit for supplying power (e.g., VGL, VGH, EVDD, and EVSS) for driving the scan driving circuit and subpixels.

Each of the plurality of subpixels SPs can control emission of a light emitting element OLED according to a data voltage supplied in synchronization with a scan signal. The scan signal can be supplied from the scan driving circuit through a gate line GL, and the data voltage can be supplied in synchronization with the scan signal through a data line DL.

For example, as illustrated in part (a) of FIG. 2 or part (b) of FIG. 2, at least one of the plurality of subpixels SPs can be expressed as an equivalent circuit including a first switching transistor ST1, a driving transistor DT, a capacitor Cst, and a light emitting element OLED.

The first switching transistor ST1 can have a first electrode (e.g., a drain electrode) electrically connected to the data line DL, a second electrode (e.g., a source electrode) electrically connected to a first node N1, and a gate electrode electrically connected to the gate line GL. The first switching transistor ST1 can transmit a data signal supplied through the data line DL to the first node N1 in response to a scan signal supplied through the gate line GL.

The capacitor Cst can be electrically connected to the first node N1 and can be charged with a voltage applied to the first node N1.

The driving transistor DT can have a first electrode (e.g., a drain electrode) electrically connected to a high-potential driving voltage EVDD, and a second electrode (e.g., a source electrode) electrically connected to a first electrode (e.g., an anode) of the light emitting element OLED. The driving transistor DT can control the amount of driving current flowing to the light emitting element OLED in response to a voltage applied to a gate electrode.

An active layer of the first switching transistor ST1 and/or the driving transistor DT can include an oxide such as IGZO (Indium-Gallium-Zinc-Oxide), but is not limited thereto.

The light emitting element OLED can output light corresponding to the driving current. The light emitting element OLED can output light corresponding to one color among red R, green G, blue B, and white W.

The light emitting element OLED can include an anode, an emission layer disposed on the anode, and a cathode supplying a common voltage. The emission layer can be implemented to emit light of the same color for each pixel, such as light of white W, or can be implemented to emit different colors for each subpixel SP, such as light of red R, green G, or blue B.

The light emitting element OLED can be a front-emitting diode or a back-emitting diode.

In part (a) of FIG. 2, a situation in which the driving transistor DT is directly connected to the light emitting element OLED is illustrated as an example, but the present disclosure is not limited thereto, and as illustrated in part (b) of FIG. 2, the driving transistor DT can be connected to the light emitting element OLED via a second switching transistor ST2.

Specifically, as illustrated in part (b) FIG. 2, the second switching transistor ST2 can be arranged between the driving transistor DT and the light emitting element OLED, and a first electrode of the second switching transistor ST2 can be connected to the driving transistor DT, and a second electrode of the second switching transistor ST2 can be electrically connected to the light emitting element OLED. In response to a light emitting signal applied to the gate electrode of the driving transistor DT, on/off of a driving current applied from the driving transistor DT to the light emitting element OLED can be controlled.

In addition, a compensation circuit for compensating a threshold voltage of the driving transistor DT, which is a driving transistor, can be further provided in the subpixel SP. The compensation circuit can include at least one transistor connected to the driving transistor DT and can be provided in the subpixel SP.

Depending on the configuration, the compensation circuit can be configured in various structures, such as 3T1C including three transistors and one capacitor Cst, 4T2C including four transistors and two capacitors Cst, or 5T2C, 6T1C, 6T2C, 7T1C, 7T2C, etc. in the subpixel SP.

Hereinafter, a description will be given of the scan driving circuit that supplies the scan signal to a pixel circuit illustrated in FIG. 2.

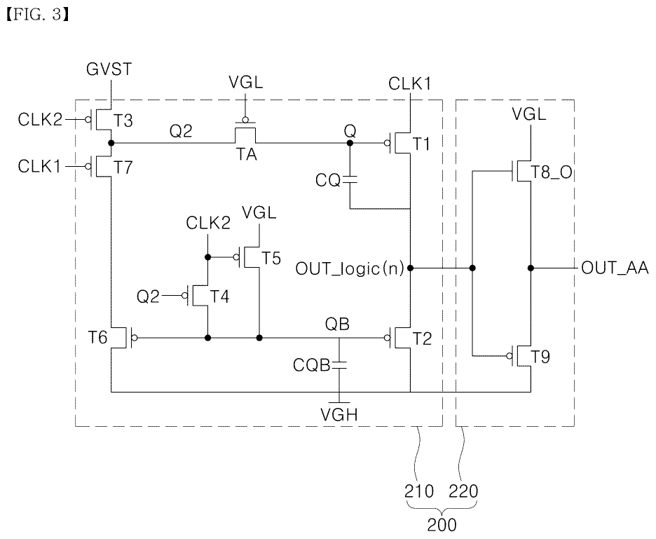

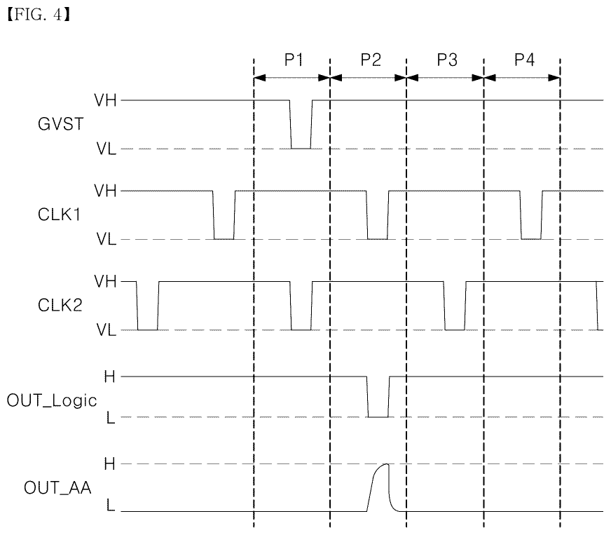

FIG. 3 is a diagram for describing a scan driving circuit according to a first embodiment of the present disclosure, and FIG. 4 is a diagram for describing an example of a timing diagram applied to the scan driving circuit according to the first embodiment.

As illustrated in FIG. 3, the scan driving circuit 200 according to the first embodiment of the present disclosure can include a logic unit 210 (e.g., logic portion) and an inverter 220.

The logic unit 210 (e.g., logic portion) can receive a plurality of clock signals CLK1 and CLK2 and a start signal GVST from the timing controller and output a logic signal through a logic output terminal OUT_Logic. When the scan driving circuit 200 includes a plurality of stages, the logic unit 210 included in the first stage that supplies the scan signal first can receive a start signal GVST from the timing controller, and the logic unit 210 included in the second or subsequent stages can receive a carry signal of the previous stage as a start signal GVST.

In order to output the logic signal, the logic unit 210 (e.g., logic portion) can include a plurality of logic transistors and a plurality of capacitors. The plurality of logic transistors included in the logic unit 210 can include p-type transistors including semiconductors formed of LTPS in order to improve the response speed characteristics of the transistors.

The inverter 220 can receive a logic signal and output a scan signal whose phase is inverted through a gate output terminal OUT_AA. That is, the scan signal output by the inverter 220 can be a signal whose phase is inverted from the logic signal. For example, when a logic signal having a gate high voltage VGH is input from the logic unit 210, the inverter 220 can output a scan signal having a gate low voltage VGL, and when a logic signal having the gate low voltage VGL is input from the logic unit 210, the inverter 220 can output a scan signal having the gate high voltage VGH.

The gate output terminal OUT_AA can be electrically connected to the gate line GL of FIG. 1. A scan signal from the inverter 220 can be input to the first switching transistor ST1 of the subpixel SP through the gate line GL.

The inverter 220 includes a first inverter transistor T8_O having n-type and a second inverter transistor T9 having p-type, and the first inverter transistor T8_O and the second inverter transistor T9 are positioned with each gate electrode connected to the logic output terminal OUT_Logic and the gate output terminal OUT_AA interposed therebetween, the first inverter transistor T8_O can include an oxide semiconductor, and the second inverter transistor T9 can include a semiconductor formed of LTPS. In other words, the first inverter transistor T8_O can be a different type of transistor than the second inverter transistor T9.

Specifically, the first inverter transistor T8_O can have the gate electrode connected to the logic output terminal OUT_Logic, one end to which the gate low voltage VGL is supplied, and the other end connected to the gate output terminal OUT_AA. The second inverter transistor T9 can have the gate electrode connected to the logic output terminal OUT_Logic, one end to which a gate high voltage VGH is supplied, and the other end connected to the gate output terminal OUT_AA.

Accordingly, the first inverter transistor T8_O can be turned on by a logic signal having the gate high voltage VGH to output the gate low voltage VGL to the gate output terminal OUT_AA, and the second inverter transistor T9 can be turned on by a logic signal having the gate low voltage VGL to output the gate high voltage VGH to the gate output terminal OUT_AA.

In the inverter 220 according to an embodiment of the present disclosure, the first and second inverter transistors are controlled by a logic signal output through the logic output terminal OUT_Logic, so that a separate clock signal for controlling the first and second inverter transistors is not needed, thereby reducing the number of clock signals. Accordingly, the structure of the inverter 220 of the present disclosure can further simplify the circuit structure and reduce the number of clock signal lines arranged on the display panel. For example, since the inverter 220 can use an n-type transistor and a p-type transistor, the inverter 220 can be effectively controlled by a same logic signal output through the logic output terminal OUT_Logic.

The logic unit 210 is illustrated as an example in FIG. 3, but can be configured in various forms including a Q-node and a QB-node, and can include a plurality of logic transistors and a plurality of capacitors, as described above. The present disclosure is not limited to the configuration of the logic unit 210 illustrated in FIG. 3. The configuration of the logic unit 210 is not limited as long as a logic signal including the gate high voltage VGH and the gate low voltage VGL is output through the logic output terminal OUT_Logic.

For example, as illustrated in FIG. 3, the logic unit 210 can include a first logic transistor T1 to a seventh logic transistor T7 that are p-type, and first and second capacitors CQ and CQB.

The first logic transistor T1 can have a gate electrode connected to the Q-node, one end to which a first clock signal CLK1 is input, and the other end connected to the logic output terminal OUT_Logic. The first logic transistor T1 can output a voltage of the first clock signal CLK1 to the logic output terminal OUT_Logic according to a potential of the Q-node.

The second logic transistor T2 can have a gate electrode connected to the QB-node, one end to which the gate high voltage VGH is supplied, and the other end connected to the logic output terminal OUT_Logic. The gate high voltage VGH can be output to the logic output terminal OUT_Logic according to a potential of the QB-node.

The third logic transistor T3 can have a gate electrode connected to the second clock signal CLK2, one end to which a start signal GVST is input, and the other end connected to the Q-node through an eighth logic transistor TA. The third logic transistor T3 can apply a potential of the start signal GVST to the Q node according to the second clock signal CLK2.

The fourth logic transistor T4 can have a gate electrode connected to the Q-node through the eighth logic transistor TA, one end to which the second clock signal CLK2 is input, and the other end connected to the QB-node. The fourth logic transistor T4 can apply a potential of the second clock signal CLK2 to the QB-node according to a potential of a Q2-node.

The fifth logic transistor T5 can have a gate electrode to which the second clock signal CLK2 is input, one end to which the gate low voltage VGL is input, and the other end connected to the QB-node. The fifth logic transistor T5 can supply the gate low voltage VGL to the QB-node according to the second clock signal CLK2.

The sixth logic transistor T6 can have a gate electrode connected to the QB-node and can output the gate high voltage VGH supplied to one end to the other end. The sixth logic transistor T6 can output the gate high voltage VGH to the seventh logic transistor T7 according to a potential of the QB-node.

The seventh logic transistor T7 can have a gate electrode to which a first clock signal CLK1 is input, one end connected to the sixth logic transistor T6, and the other end connected to the Q-node through the eighth logic transistor TA. The seventh logic transistor T7 can supply the gate high voltage VGH supplied through the sixth logic transistor T6 to the Q-node according to the first clock signal CLK1.

The eighth logic transistor TA has a gate electrode to which the gate low voltage VGL is supplied, and can be connected between the gate electrode of the first logic transistor T1 and the other end of the third logic transistor T3. That is, the eighth logic transistor TA can be positioned on the Q-node.

In FIG. 3, for convenience, one side of the eighth logic transistor TA is indicated as the Q2-node, and the other side is indicated as the Q-node. However, since the eighth logic transistor TA is always supplied with the gate low voltage VGL through the gate electrode and maintained in a turned-on state, the potentials of the Q-node and the Q2-node can have substantially the same potential as long as the logic unit 210 is normally operated.

The eighth logic transistor TA can prevent damage to the first logic transistor T1 due to overvoltage. Specifically, if the eighth logic transistor TA is not provided, when an overvoltage exceeding a driving range is applied to the Q2-node due to an operation error of the circuit, etc., the first logic transistor T1 can be damaged.

However, if the eighth logic transistor TA is provided, when an overvoltage is applied to the Q2-node, the eighth logic transistor TA is turned off, so that the Q2-node and the Q-node are electrically separated from each other, thereby preventing the overvoltage of the Q2-node from being transmitted to the Q-node, and preventing damage to the first logic transistor T1.

The first capacitor CQ can have one end connected to the Q-node and the other end connected to the logic output terminal OUT_Logic. The first capacitor CQ can be charged with the potential applied to the Q-node and maintain the potential. Therefore, unless the Q-node is floating or a currently applied potential of the Q-node is different from a previously applied potential, the potential of the Q-node can be maintained at the same potential by the first capacitor CQ.

The second capacitor CQB can have one end connected to the QB-node and the other end supplied with the logic high voltage VH (e.g., VGH). The second capacitor CQB can be charged with the potential applied to the QB-node and maintain the potential. Therefore, unless the QB-node is floating or a current supply voltage of the QB-node is different from a previous supply voltage, the potential of the QB-node can be maintained at the same potential by the second capacitor CQB.

Here, the gate high voltage VGH and the gate low voltage VGL can be supplied from a power supply, and the first and second clock signals CLK1 and CLK2 and the start signal GVST can be supplied from the timing controller.

As illustrated in FIG. 4, the timing diagram applied to the scan driving circuit 200 according to the first embodiment can include a first period P1 to a fourth period P4 during one cycle.

In the first period P1, the start signal GVST and the second clock signal CLK2 can have the logic low voltage VL (e.g., VGL), and the first clock signal CLK1 can have the logic high voltage VH (e.g., VGH). Accordingly, the logic unit 210 can output the gate high voltage VGH through the logic output terminal OUT_Logic, and the inverter 220 can output a scan signal having the gate low voltage VGL through the gate output terminal OUT_AA.

In the second period P2 after the first period P1, the first clock signal CLK1 can have the logic low voltage VL, and the second clock signal CLK2 and the start signal GVST can have the logic high voltage VH. Accordingly, the logic unit 210 can output the gate low voltage VGL through the logic output terminal OUT_Logic, and the inverter 220 can output a scan signal having the gate high voltage VGH through the gate output terminal OUT_AA.

In the third period P3 after the second period P2, the second clock signal CLK2 can have the logic low voltage VL, and the first clock signal CLK1 and the start signal GVST can have the logic high voltage VH. Accordingly, the logic unit 210 can output the gate high voltage VGH through the logic output terminal OUT_Logic, and the inverter 220 can output a scan signal having the gate low voltage VGL through the gate output terminal OUT_AA.

In the fourth period P4 after the third period P3, the first clock signal CLK1 can have the logic low voltage VL, and the second clock signal CLK2 and the start signal GVST can have the logic high voltage VH. Accordingly, the logic unit 210 can output the gate high voltage VGH through the logic output terminal OUT_Logic, and the inverter 220 can output a scan signal having the gate low voltage VGL through the gate output terminal OUT_AA.

Hereinafter, a detailed description will be given of an operation method of the scan driving circuit 200 according to the first embodiment according to a timing diagram such as FIG. 4.

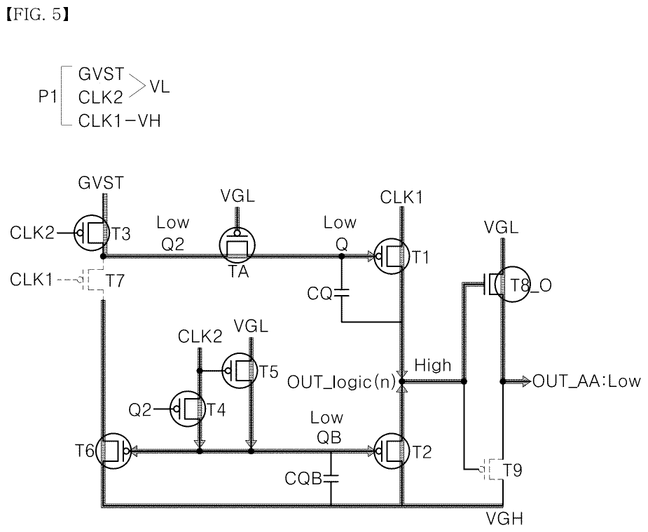

FIGS. 5 to 8 are diagrams for describing the operation method of the scan driving circuit according to the first embodiment according to the timing diagram of FIG. 4.

During the first period P1 to the fourth period P4, the gate low voltage VGL is supplied to the gate electrode of the eighth logic transistor TA, so that the eighth logic transistor TA can be turned on during the first period P1 to the fourth period P4, and the potential of the Q2-node can be the same as the potential of the Q-node.

In the first period P1, with reference to FIG. 5, the start signal GVST and the second clock signal CLK2 can have the logic low voltage VL, and the first clock signal CLK1 can have the logic high voltage VH. Accordingly, the third logic transistor T3 is turned on by the second clock signal CLK2, so that the logic low voltage VL of the start signal GVST can be supplied to the Q2-node and the Q-node, and the Q-node can be charged with the logic low voltage VL by the first capacitor CQ.

In addition, the first logic transistor T1 can be turned on according to the logic low voltage VL of the Q-node, so that the logic high voltage VH of the first clock signal CLK1 can be output through the logic output terminal OUT_Logic.

In addition, the fourth logic transistor T4 can be turned on according to the logic low voltage VL of the Q2-node, so that the logic low voltage VL of the second clock signal CLK2 can be supplied to the QB-node, and the fifth logic transistor T5 can be turned on according to the logic low voltage VL of the second clock signal CLK2, so that the gate low voltage VGL can be supplied to the QB-node.

Accordingly, the QB-node can be charged with the gate low voltage VGL by the second capacitor CQB. According to the logic low voltage VL of the QB-node, the second logic transistor T2 is also turned on, and the gate high voltage VGH can also be output through the logic output terminal OUT_Logic via the second logic transistor T2.

Accordingly, the first inverter transistor T8_O is turned on by receiving the gate high voltage VGH from the logic output terminal OUT_Logic, and the inverter 220 can output a scan signal having the gate low voltage VGL through the gate output terminal OUT_AA.

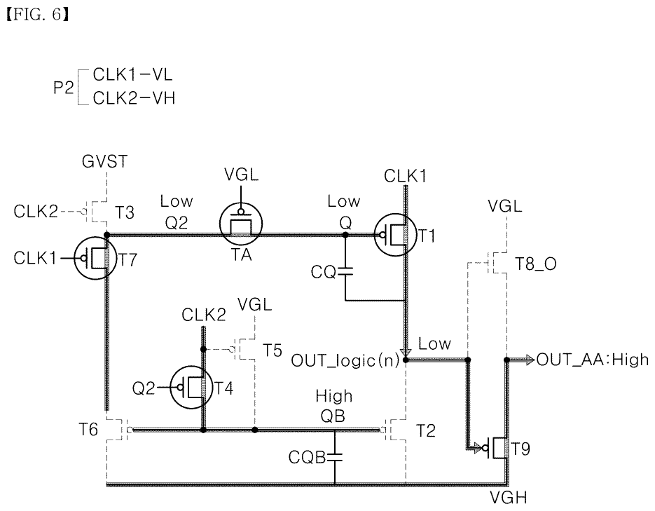

In the second period P2, with reference to FIG. 6, the first clock signal CLK1 can have the logic low voltage VL, and the second clock signal CLK2 can have the logic high voltage VH. Accordingly, the third logic transistor T3 is turned off, the start signal GVST is blocked, and the Q2-node and the Q-node can maintain the logic low voltage VL of the first period P1 by the charge potential of the first capacitor CQ. Accordingly, the first logic transistor T1 is turned on, and the logic low voltage VL of the first clock signal CLK1 can be output through the logic output terminal OUT_Logic.

In addition, as the Q2-node maintains the logic low voltage VL, the fourth logic transistor T4 can be turned on, and the fifth logic transistor T5 can be turned off. Accordingly, the logic high voltage VH of the second clock signal CLK2 is applied to the QB-node, so that the QB-node can be charged with the logic high voltage VH by the second capacitor CQB. The second logic transistor T2 and the sixth logic transistor T6 can be turned off by the logic high voltage VH of the QB-node.

Accordingly, the second inverter transistor T9 is turned on by receiving the gate low voltage VGL from the logic output terminal OUT_Logic, so that the inverter 220 can output a scan signal having the gate high voltage VGH through the gate output terminal OUT_AA.

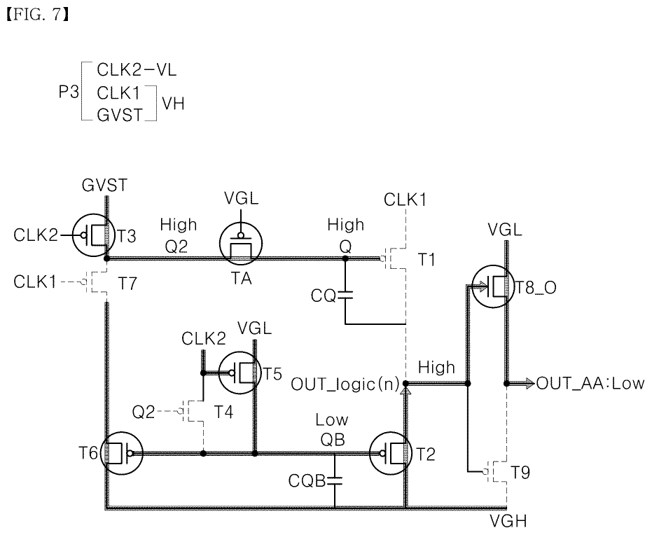

In the third period P3, with reference to FIG. 7, the second clock signal CLK2 can have the logic low voltage VL, and the first clock signal CLK1 and the start signal GVST can have the logic high voltage VH.

The third logic transistor T3 is turned on by the second clock signal CLK2, so that the logic high voltage VH of the start signal GVST can be supplied to the Q2-node and the Q-node, and the Q-node can be charged with the logic high voltage VH by the first capacitor CQ. In addition, the first logic transistor T1 can be turned off according to the logic high voltage VH of the Q-node.

In addition, the fifth logic transistor T5 can be turned on according to the logic low voltage VL of the second clock signal CLK2, so that the gate low voltage VGL can be supplied to the QB-node. Accordingly, the QB-node can be charged with the gate low voltage VGL by the second capacitor CQB. According to the logic low voltage VL of the QB-node, the second logic transistor T2 can be turned on, so that the gate high voltage VGH can be output through the logic output terminal OUT_Logic.

Accordingly, the first inverter transistor T8_O can be turned on by receiving the gate high voltage VGH through the logic output terminal OUT_Logic, and the inverter 220 can output a scan signal having the gate low voltage VGL through the gate output terminal OUT_AA.

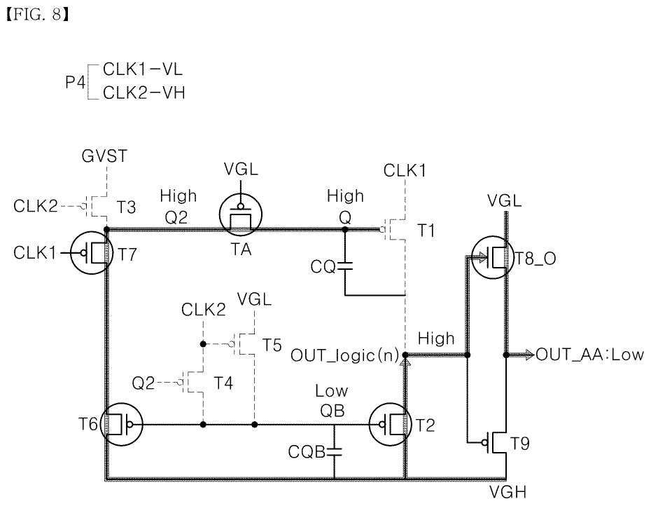

In the fourth period P4, with reference to FIG. 8, the first clock signal CLK1 can have the logic low voltage VL, and the second clock signal CLK2 can have the logic high voltage VH. Accordingly, the seventh logic transistor T7 can be turned on, and the third logic transistor T3 can be turned off.

The potential of the QB-node can be maintained as the logic low voltage VL identical to the potential in the third period P3. The second logic transistor T2 and the sixth logic transistor T6 can be turned on by the logic low voltage VL of the QB-node. The second logic transistor T2 can be turned on, and the gate high voltage VGH can be output through the logic output terminal OUT_Logic. In addition, the sixth logic transistor T6 can be turned on, and the gate high voltage VGH can be supplied to the Q-node through the seventh logic transistor T7.

Accordingly, the first inverter transistor T8_O is turned on by receiving the gate high voltage VGH through the logic output terminal OUT_Logic, and the inverter 220 can output a scan signal having the gate low voltage VGL through the gate output terminal OUT_AA.

In this way, the present disclosure can reduce the number of clock signals by having the first inverter transistor T8_O of the n type and the second inverter transistor T9 of the p type, which are commonly connected to the logic output terminal OUT_Logic. For example, by using a configuration design that includes a pair of different types of transistors in the inverter 220 (e.g., one n-type and one p-type) that are wired to the same output, this specific combination can provide a more elegant circuit design and allow it to operate with fewer clock signals.

In addition, the first inverter transistor T8_O includes an oxide semiconductor, so that a scan signal having the gate low voltage VGL can be stably supplied to the pixel circuit through the gate output terminal OUT_AA. Accordingly, the scan driving circuit 200 of the present disclosure can minimize malfunction of the pixel circuit. For example, the oxide semiconductor can allow the first inverter transistor T8_O to supply a stable and consistent low-voltage signal to the pixels, which can prevent the pixels from glitching or malfunctioning.

Meanwhile, the scan driving circuit 200 according to the first embodiment can supply a scan signal having the gate high voltage VGH supplied for a significantly short period during a frame period of one cycle, and supply a scan signal having the gate low voltage VGL during a remaining period of the frame period.

Accordingly, a period during which the gate high voltage VGH of the logic signal is supplied from the inverter 220 to the gate electrode of the first inverter transistor T8_O can be longer than a period during which the gate low voltage VGL of the logic signal is supplied. For example, the first inverter transistor T8_O can be turned on during first, third, and fourth periods P1, P3, and P4 excluding a second period P2.

That is, while the scan driving circuit 200 according to the first embodiment outputs a scan signal of the gate low voltage VGL, the first inverter transistor T8_O including an oxide semiconductor can be continuously turned on.

When the first inverter transistor T8_O including the oxide semiconductor is continuously turned on, the first inverter transistor T8_O can be subjected to Positive Bias Thermal Stress (PBTS), and a threshold voltage Vth of the first inverter transistor T8_O can shift in a positive+direction due to the PBTS.

Such PBTS can become severe when the scan driving circuit 200 is driven at a low speed, in a high temperature environment, or for a long time. As a result, an operation error of the first inverter transistor T8_O may occur, the gate low voltage VGL of the scan signal may not be stably maintained, resulting in driving failure, and reliability of the display device 100 may become degraded.

Considering this point, the present disclosure can add a structure (e.g., BE, SW1, and SW2) that prevents driving failure of the first inverter transistor T8_O.

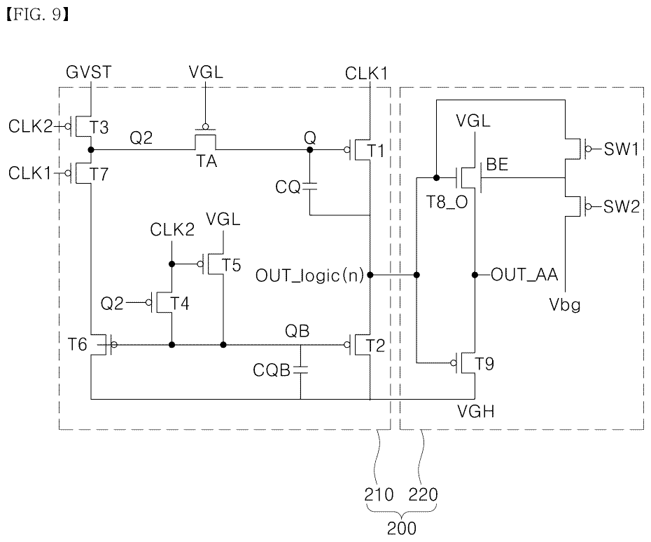

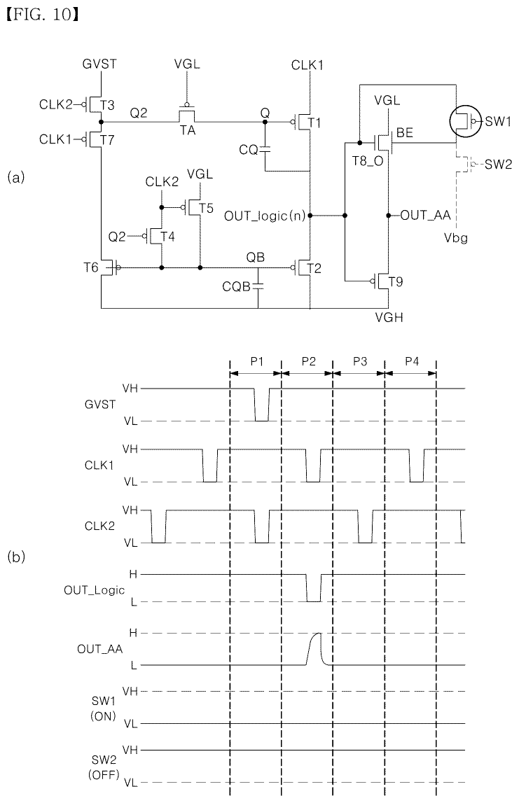

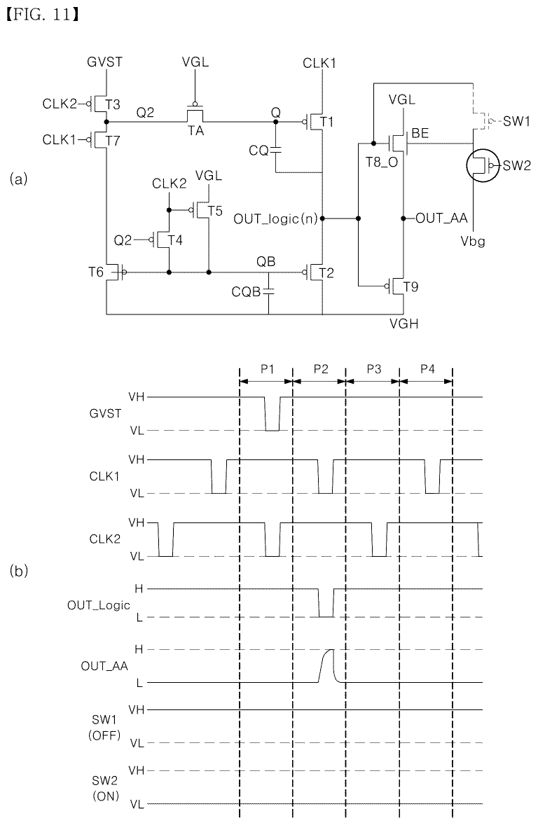

FIG. 9 is a diagram for describing a scan driving circuit according to a second embodiment of the present disclosure, FIG. 10 is a diagram for describing an operation of the scan driving circuit according to the second embodiment during high-speed operation at a first scan rate or higher, and FIG. 11 is a diagram for describing an operation of the scan driving circuit according to the second embodiment during low-speed operation at less than the first scan rate.

In FIGS. 9 to 11, content overlapping content described above with reference to FIGS. 3 to 8 is replaced with content of FIGS. 3 to 8, and other parts are mainly described.

The scan driving circuit 200 according to the second embodiment illustrated in FIG. 9 can compensate for or prevent a phenomenon in which the first inverter transistor T8_O deteriorates and positively shifts under low-speed driving conditions, high-temperature environmental conditions, or long-term driving conditions.

Specifically, in the scan driving circuit 200 according to the second embodiment of the present disclosure, the first inverter transistor T8_O includes a bottom electrode BE positioned on the other side of the gate electrode with respect to the oxide semiconductor, and can further include a first switch SW1 and a second switch SW2. For example, the first inverter transistor T8_O can include a configuration that has a sandwich type of arrangement in which a bottom electrode is placed on one side of the oxide material, and the gate electrode is on the other (e.g., the gate can be above the active layer of T8_0 and the bottom electrode can be below the active layer of T8_0). Additionally, this configuration can be connected to two switches (SW1 and SW2).

The first switch SW1 can have one end connected to the gate electrode and the other end connected to the bottom electrode BE, and the second switch SW2 can have one end connected in common to both of the bottom electrode BE and the first switch SW1, and the other end to which a constant voltage Vbg is supplied. For example, the first switch SW1 and the second switch SW2 can each include a P-type transistor.

For example, first switch SW1 can increase a response speed of the first inverter transistor T8_O by connecting the gate electrode and the bottom electrode BE of the first inverter transistor T8_O when the scan driving circuit 200 according to the second embodiment is in normal driving or high-speed driving. For example, during normal or high-speed operation, the first switch SW1 can connect the transistor's top (gate) and bottom electrodes together, in which this direct connection can boost the response speed of the first inverter transistor T8_O. In other words, during normal or high-speed operation the first switch SW1 can operate as a dual-gate transistor in which a more powerful electrical field can be applied to opposite sides of the active layer to form a better conductive channel (e.g., higher drive current and faster response time).

The second switch SW2 can compensate for a phenomenon in which the first inverter transistor T8_O deteriorates and becomes positively shifted by connecting a back bias power supply having the constant voltage Vbg to the bottom electrode BE of the first inverter transistor T8_O during in low-speed driving. For example, during low-speed driving (which can stress out the transistor), the second switch SW2 can turn on and apply a steady, corrective voltage (e.g., “back bias”) to the bottom electrode of the first inverter transistor T8_O, which can counteract the stress and prevent the transistor's electrical properties from shifting.

More specifically, while the scan driving circuit 200 outputs a scan signal at the first scan rate or higher, the first switch SW1 can be turned on and the second switch SW2 can be turned off, as shown in part (a) of FIG. 10.

The first scan rate can be set based on, for example, 60 Hz. However, the present disclosure is not limited thereto, and the standard of the first scan rate can vary. However, for convenience of description, the following description will be given using a situation where the first scan rate is 60 Hz as an example.

Therefore, when the scan driving circuit 200 according to the second embodiment performs general driving to output a scan signal at a speed of 60 Hz, or the scan driving circuit 200 performs high-speed driving to output a scan signal at a high speed of 120 Hz, the first switch SW1 can be turned on and the second switch SW2 can be turned off. Therefore, for example, as illustrated in part (b) of FIG. 10, during the first period P1 to the fourth period P4, a signal of the logic low voltage VL can be applied to the gate electrode of the first switch SW1 to turn on the first switch SW1, and a signal of the logic high voltage VH can be applied to the gate electrode of the second switch SW2 to turn off the second switch SW2.

Accordingly, the gate electrode and the bottom electrode BE of the first inverter transistor T8_O can be connected together to each other by the first switch SW1, thereby increasing the response speed of the first inverter transistor T8_O (e.g., applies the electrical field to opposite sides of the active layer).

In addition, while the scan driving circuit 200 according to the second embodiment outputs a scan signal at a rate less than the first scan rate, as illustrated in part (a) of FIG. 11, the first switch SW1 can be turned off and the second switch SW2 can be turned on.

Therefore, when the scan driving circuit 200 according to the second embodiment is driven at a low speed, so that for example, a scan signal is output at a speed of 30 Hz or 1 Hz, which is lower than 60 Hz, the scan driving circuit 200 is operated at a first temperature higher than a preset temperature, or the scan driving circuit 200 is operated for a long time longer than a preset time, the first switch SW1 can be turned on and the second switch SW2 can be turned off.

Therefore, for example, as shown in part (b) of FIG. 11, during the first period P1 to the fourth period P4, a signal of the logic high voltage VH can be applied to the gate electrode of the first switch SW1, thereby turning off the first switch SW1, and a signal of the logic low voltage VL can be applied to the gate electrode of the second switch SW2, thereby turning on the second switch SW2.

Accordingly, a back bias power supply is connected to the bottom electrode BE of the first inverter transistor T8_O, so that Positive Bias Thermal Stress (PBTS) of the first inverter transistor T8_O can be prevented, reliability of the scan driving circuit 200 can be improved, and reliability of the display device 100 can be improved. For example, if the back bias is not applied during low speed driving, then the PBTS stress can cause the threshold voltage of first inverter transistor T8_O to shift higher, which means the minimum voltage at the gate to turn the transistor on becomes higher, which can waste power in the long run and potentially lead to image defects or timing errors.

In this way, the embodiments of the present disclosure can reduce the number of clock signals and simplify the operation by including the inverter having the n-type first inverter transistor and the p-type second inverter transistor commonly connected to the logic output terminal of the logic unit of the scan driving circuit.

In the embodiments of the present disclosure, the first inverter transistor includes an oxide semiconductor, so that the scan signal can be prevented from becoming unstable due to the leakage current of the first inverter transistor and malfunction of the pixel circuit can be minimized.

The embodiments of the present disclosure can prevent PBTS of the first inverter transistor and mitigate the operation error of the scan driving circuit by the first inverter transistor including a bottom electrode and further including a first switch and a second switch connected to the bottom electrode.

The embodiments of the present disclosure can reduce the number of clock signals and simplify the operation by including the inverter having the n-type first inverter transistor and the p-type second inverter transistor commonly connected to the logic output terminal of the logic unit of the scan driving circuit.

In the embodiments of the present disclosure, the first inverter transistor includes an oxide semiconductor, so that the scan signal can be prevented from becoming unstable due to the leakage current of the first inverter transistor and malfunction of the pixel circuit can be minimized.

The embodiments of the present disclosure can prevent PBTS of the first inverter transistor that is likely to occur during low-speed driving and mitigate the operation error of the scan driving circuit by the first inverter transistor including the bottom electrode and further including a first switch that connects the gate electrode and the bottom electrode of the first inverter transistor during high-speed driving and a second switch that connects the bottom electrode of the first inverter transistor and a constant voltage during low-speed driving.

Through the above description, those skilled in the art will be able to understand that various changes and modifications are possible within the scope that does not deviate from the technical idea of the present disclosure. Therefore, the technical scope of the present disclosure should not be limited to content described in the detailed description of the specification, but should be determined by the scope of the patent claims.

What is claimed is:

1. A display device comprising:
a pixel circuit configured to drive a light emitting element; and
a scan driving circuit configured to supply a scan signal to the pixel circuit,
wherein the scan driving circuit includes:
a logic portion configured to receive a plurality of clock signals and output a logic signal through a logic output terminal; and
an inverter configured to receive the logic signal and output the scan signal with a phase of the logic signal inverted through a gate output terminal,
wherein the inverter includes a first inverter transistor and a second inverter transistor, the first inverter transistor being an n-type transistor and the second inverter transistor being a p-type transistor,
wherein a gate electrode of the first inverter transistor and a gate electrode of the second inverter transistor are both connected to the logic output terminal of the logic portion,
wherein the first inverter transistor and the second inverter transistor are both connected to the gate output terminal, and
wherein the first inverter transistor includes an oxide semiconductor.

2. The display device according to claim 1, wherein the logic portion is further configured to:
supply the logic signal having a gate high voltage to the gate electrode of the first inverter transistor and the logic signal having a gate low voltage to the gate electrode of the first inverter transistor,
wherein a period during which the gate high voltage of the logic signal is supplied to the gate electrode of the first inverter transistor is longer than a period during which the gate low voltage of the logic signal is supplied to the gate electrode of the first inverter transistor.

3. The display device according to claim 1, wherein the second inverter transistor is a low temperature polysilicon (LTPS) transistor.

4. The display device according to claim 1, wherein the first inverter transistor includes a gate electrode connected to the logic output terminal of the logic portion, a first end configured to receive a gate low voltage, and a second end connected to the gate output terminal, and
wherein the second inverter transistor includes a gate electrode connected to the logic output terminal of the logic portion, a first end configured to receive a gate high voltage, and a second end connected to the gate output terminal.

5. The display device according to claim 1, wherein the first inverter transistor is configured to be turned on by the logic signal having a gate high voltage to output the scan signal having a gate low voltage to the gate output terminal, and
wherein the second inverter transistor is configured to be turned on by the logic signal having a gate low voltage to output the scan signal having the gate high voltage to the gate output terminal.

6. The display device according to claim 1, wherein the logic portion includes a plurality of logic transistors, and
wherein the plurality of logic transistors include one or more low temperature polysilicon (LTPS) transistors.

7. The display device according to claim 1, wherein the logic portion includes:
a first logic transistor having a gate electrode connected to a Q-node, a first end configured to receive a first clock signal, and a second end connected to the logic output terminal;
a second logic transistor having a gate electrode connected to a QB-node, a first end configured to receive a gate high voltage, and a second end connected to the logic output terminal;
a third logic transistor having a gate electrode configured to receive a second clock signal, a first end configured to receive a start signal, and a second end connected to the Q-node;
a fourth logic transistor having a gate electrode connected to the Q-node, a first end configured to receive the second clock signal, and a second end connected to the QB-node;
a fifth logic transistor having a gate electrode configured to receive the second clock signal, a first end configured to receive a gate low voltage, and a second end connected to the QB-node;
a sixth logic transistor having a gate electrode connected to the QB-node, a first end configured to receive a gate high voltage, and a second end configured to output the gate high voltage;
a seventh logic transistor having a gate electrode configured to receive the first clock signal, a first end connected to the sixth logic transistor, and a second end connected to the Q-node;
a first capacitor having a first end connected to the Q-node, and a second end connected to the logic output terminal; and
a second capacitor having a first end connected to the QB-node, and a second end configured to receive the gate high voltage.

8. The display device according to claim 7, wherein the logic portion further includes:
an eighth logic transistor having a gate electrode configured to receive the gate low voltage, the eight logic transistor being connected between the gate electrode of the first logic transistor and the second end of the third logic transistor.

9. The display device according to claim 7, wherein in a first period, the start signal and the second clock signal have a logic low voltage, and the first clock signal has a logic high voltage,
wherein in a second period after the first period, the first clock signal has a logic low voltage, and the second clock signal has a logic high voltage,
wherein in a third period after the second period, the second clock signal has a logic low voltage, and the first clock signal and the start signal have a logic high voltage, and
wherein in a fourth period after the third period, the first clock signal has a logic low voltage, and the second clock signal has a logic high voltage.

10. The display device according to claim 1, wherein the first inverter transistor includes a bottom electrode, the gate electrode of the first inverter transistor and the bottom electrode being positioned on opposite sides of the oxide semiconductor, and
wherein the display device further comprises:
a first switch having a first end connected to the gate electrode of the first inverter transistor and a second end connected to the bottom electrode; and
a second switch having a first end connected in common to both of the bottom electrode and the first switch, and a second end configured to receive a constant voltage.

11. The display device according to claim 10, wherein the first switch is turned on and the second switch is turned off while the scan driving circuit outputs the scan signal at a first scan rate or higher.

12. The display device according to claim 11, wherein the first switch is turned off and the second switch is turned on while the scan driving circuit outputs the scan signal at a scan rate less than a first scan rate.

13. A scan driving circuit comprising:
a logic portion configured to receive a plurality of clock signals and output a logic signal through a logic output terminal to supply a scan signal to a pixel circuit; and
an inverter configured to receive the logic signal and output the scan signal with a phase of the logic signal inverted through a gate output terminal,
wherein the inverter includes a first inverter transistor and a second inverter transistor, the first inverter transistor being an n-type transistor and the second inverter transistor being a p-type transistor, and the first inverter transistor and the second inverter transistor are both connected to the gate output terminal, and
wherein the first inverter transistor includes an oxide semiconductor.

14. The scan driving circuit according to claim 13, wherein the logic portion is further configured to:
supply the logic signal having a gate high voltage to a gate electrode of the first inverter transistor and the logic signal having a gate low voltage to the gate electrode of the first inverter transistor,
wherein a period during which the gate high voltage of the logic signal is supplied to the gate electrode of the first inverter transistor is longer than a period during which the gate low voltage of the logic signal is supplied to the gate electrode of the first inverter transistor.

15. The scan driving circuit according to claim 13, wherein the second inverter transistor is a low temperature polysilicon (LTPS) transistor.

16. The scan driving circuit according to claim 13, wherein the first inverter transistor includes a gate electrode connected to the logic output terminal of the logic portion, a first end configured to receive a gate low voltage, and a second end connected to the gate output terminal, and
wherein the second inverter transistor includes a gate electrode connected to the logic output terminal of the logic portion, a first end configured to receive a gate high voltage, and a second end connected to the gate output terminal.

17. The scan driving circuit according to claim 13, wherein the first inverter transistor is configured to be turned on by the logic signal having a gate high voltage to output the scan signal having a gate low voltage to the gate output terminal, and
wherein the second inverter transistor is configured to be turned on by the logic signal having a gate low voltage to output the scan signal having the gate high voltage to the gate output terminal.

18. The scan driving circuit according to claim 13, wherein the first inverter transistor includes a bottom electrode, the gate electrode of the first inverter transistor and the bottom electrode being positioned on opposite sides of the oxide semiconductor, and
wherein the scan driving circuit further comprises:
a first switch having a first end connected to the gate electrode of the first inverter transistor and a second end connected to the bottom electrode; and
a second switch having a first end connected in common to both of the bottom electrode and the first switch, and a second end configured to receive a constant voltage.

19. The scan driving circuit according to claim 18, wherein the first switch is turned on and the second switch is turned off while the scan driving circuit outputs the scan signal at a first scan rate or higher.

20. The scan driving circuit according to claim 19, wherein the first switch is turned off and the second switch is turned on while the scan driving circuit outputs the scan signal at a scan rate less than a first scan rate.

21. A scan driving circuit comprising:
a logic portion configured to receive a plurality of clock signals and output a logic signal through a logic output terminal; and
an inverter configured to receive the logic signal and output the scan signal with a phase of the logic signal inverted through a gate output terminal,
wherein the inverter includes a first inverter transistor and a second inverter transistor, the first inverter transistor being an n-type transistor and the second inverter transistor being a p-type transistor.

22. The scan driving circuit according to claim 21, wherein the first inverter transistor is an oxide thin film transistor, and the second inverter transistor is a low temperature polysilicon (LTPS) thin film transistor.

23. The scan driving circuit according to claim 21, wherein the first inverter transistor includes an active layer, and a first gate electrode and a second gate electrode positioned on opposite sides of the active layer,
wherein the scan driving circuit further comprises:
a first switch having a first end connected to the gate electrode of the first inverter transistor and a second end connected to the second gate electrode; and
a second switch having a first end connected in common to both of the second gate electrode and the first switch, and a second end configured to receive a constant voltage.

24. The scan driving circuit according to claim 23, wherein the scan driving circuit is configured to:
in response to operating in a first mode, turn the first switch on to electrically connect the second gate electrode with the first gate electrode while the second switch is turned off, and
in response to operating in a second mode, turn the first switch off and turn the second switch on to supply a back bias voltage to the second gate electrode of the first inverter transistor.

25. The scan driving circuit according to claim 24, wherein the first mode corresponds to a high-speed driving mode based on a first scan rate, and
wherein the second mode corresponds to a low-speed driving mode or a power saving mode, based on a second scan rate less than the first scan rate.
